(19) United States
(12) Patent Application Publication
(10) Pub. No.: US 2022/0292476 A1
(43) Pub. Date: Sep. 15, 2022

(54) INFORMATION PROCESSING DEVICE, PROGRAM, AND INFORMATION PROCESSING SYSTEM

(71) Applicant: Toshiba Tec Kabushiki Kaisha, Tokyo (JP)

(72) Inventors: Toyoki HIRASAWA, Shiki (JP); Makoto NOZAWA, Sunto (JP)

(73) Assignee: Toshiba Tec Kabushiki Kaisha, Tokyo (JP)

(21) Appl. No.: 17/548,280

(22) Filed: Dec. 10, 2021

(30) Foreign Application Priority Data
Mar. 15, 2021 (JP) 2021-041814

(51) Int. Cl. G06Q 20/18; G06K 7/14

(52) U.S. Cl. CPC G06Q 20/18; G06K 7/1417

(57) ABSTRACT

An information processing device includes a first receiving unit configured to receive, from a terminal device that performs settlement of a commodity, an individual article code capable of identifying the commodity in an individual article unit, a storage control unit configured to store the individual article code in a storing unit, a second receiving unit configured to receive, from a gate device provided in a predetermined position of a store, the individual article code of the commodity obtained by the gate device reading a wireless tag attached to the commodity, a collating unit configured to collate the individual article code received by the second receiving unit with each of individual article codes stored in the storing unit, and an informing unit configured to inform if, as a result of the collation, a coinciding individual article code is absent in the storing unit.

### CROSS-REFERENCE TO RELATED APPLICATION

This application is based upon and claims the benefit of priority from Japanese Patent Application No. 2021-041814, filed on Mar. 15, 2021, the entire contents of which are incorporated herein by reference.

### FIELD

Embodiments described herein relate generally to an information processing device, a program, and an information processing system.

### BACKGROUND

In a store, such as a supermarket or a convenience store, a self-service settlement device with which a customer himself or herself performs operation(s) relating to settlement has been used. Recently, the customer is capable of performing settlement of commodities using a terminal device, such as a smartphone carried by the customer.

In the settlement scheme in which the customer himself or herself performs settlement, it is not easy for a store to discriminate (determine) which customer already performed settlement. In particular, if a terminal device such as a smartphone is used for settlement, since a place for performing settlement is not decided, it is difficult to discriminate whether a customer already performed settlement. It is likely that a fraudulent act of taking out a commodity to the outside of the store without performing settlement cannot be prevented.

Concerning such problems, a system has been proposed for, at a reading time of code data attached to a commodity, recording a status indicating “settled” or the like in a wireless tag attached to the commodity and detecting a state of the status in a security gate to determine lawfulness.

### DESCRIPTION OF THE DRAWINGS

FIG. 1 is a diagram illustrating an example of the configuration of a store system according to at least one embodiment;

FIG. 2 is a diagram schematically illustrating an example of a label attached to a commodity;

FIG. 3 is a diagram schematically illustrating an example of code data retained by a code symbol;

FIG. 4 is a diagram illustrating an example of a hardware configuration of a terminal device according to at least one embodiment;

FIG. 5 is a diagram illustrating an example of a hardware configuration of a gate device;

FIG. 6 is a diagram illustrating an example of a hardware configuration of a server device;

FIG. 7 is a diagram illustrating an example of a data configuration of a commodity master;

FIG. 8 is a diagram illustrating an example of functional configurations of the terminal device, the server device, and the gate device;

FIG. 9 is a flowchart illustrating an example of processing executed by the server device;

FIG. 10 is a flowchart illustrating another example of processing;

FIG. 11 is a diagram schematically illustrating an example of a data configuration of an individual article code stored by a data storing unit according to a first modification;

FIG. 12 is a flowchart illustrating an example of processing executed by a server device according to the first modification; and

FIG. 13 is a flowchart illustrating another example of the processing.

### DETAILED DESCRIPTION

Techniques as described above cannot be applied if a function capable of reading and writing a wireless tag is not provided for a settlement device. In particular, such devices are inferior for fraud-prevention purposes where functionality for reading and writing a wireless tag and the like are not generally provided on a terminal device such as a smartphone carried by a customer.

An object of at least one embodiment is to provide, in order to solve the problems described above, an information processing device, a program, and an information processing system capable of performing detection of an unsettled commodity in a settlement scheme in which settlement is performed by operation of a customer himself or herself.

An information processing device according to at least one embodiment includes: a first receiving unit (receiver) configured to receive, from a terminal device that performs settlement of a commodity, an individual article code capable of identifying the commodity in an individual article unit, the individual article code being obtainedby the terminal device reading a code symbol attached to the commodity; a storage control unit (controller) configured to store the individual article code received by the first receiving unit in a storing unit (storage); a second receiving unit (receiver) configured to receive, from a gate device provided in a predetermined position of a store selling the commodity, the individual article code of the commodity obtained by the gate device reading a wireless tag attached to the commodity; a collating unit (collater) configured to collate the individual article code received by the second receiving unit with each of individual article codes stored in the storing unit; and an informing unit (communication interface, informer or notifier) configured to inform if, as a result of the collation, a coinciding individual article code is absent in the storing unit.

At least one embodiment of an information processing device, a program, and an information processing system according is explained in detail below with reference to the drawings. In an embodiment as explained below, an example is explained in which the information processing device, the program, and the information processing system are applied to a retail store (a store) such as a supermarket or a convenience store. However, embodiments are not limited to this embodiment.

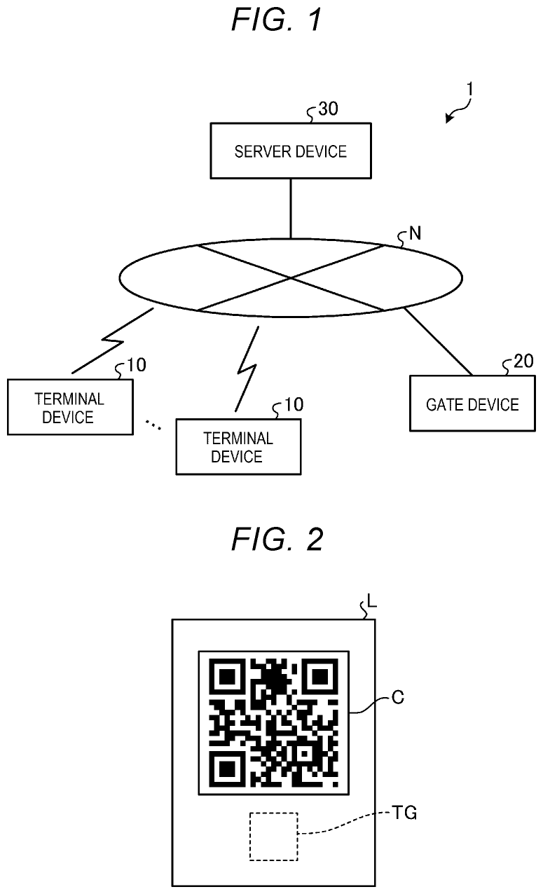

FIG. 1 is a diagram illustrating an example of the configuration of a store system according to at least one embodiment. As illustrated in FIG. 1, a store system 1 is an example of an information processing system and includes terminal devices 10, a gate device 20, and a server device 30. The terminal devices 10 and the gate device 20 are communicably connected to the server device 30 via a wired or wireless network N.

The terminal device 10 is an example of a terminal device and is used by a customer who purchases commodities. The terminal device 10 may be a portable terminal device such as a smartphone or a tablet terminal. In this case, the terminal device 10 may be a terminal device carried by a customer or may be a terminal device lent from the store. The terminal device 10 may be a terminal device such as a tablet terminal attached to a mobile body such as a shopping cart. The terminal device 10 maybe a POS terminal of a so-called semi-self-service or self-service type, with which a customer himself or herself performs registration and settlement of commodities, set in the store. In at least one embodiment, the terminal device 10 is described as a terminal carried by the customer. However, the terminal device 10 is not limited to this.

The terminal device 10 reads a code symbol C (see FIG. 2) such as a two-dimensional code or a barcode attached to a commodity and executes settlement processing based on information read from the code symbol C. When the settlement processing is completed, the terminal device 10 transmits an individual article code explainedbelow read from the code symbol C to the server device 30.

The gate device 20 is an example of a gate device and is provided in a predetermined position of the store. The gate device 20 is provided, for example, at an exit of the store that a customer visiting the store always passes. In this embodiment, a configuration in which the gate device 20 is provided at the exit of the store is explained.

The gate device 20 reads a wireless tag (see FIG. 2) such as an RFID (Radio Frequency Identifier) tag attached to a commodity and transmits an individual article code retained by the wireless tag to the server device 30.

A code symbol and a wireless tag attached to a commodity are explained. FIG. 2 is a diagram schematically illustrating an example of a label attached to a commodity. In this embodiment, a label L such as a commodity label or a commodity tag is attached to each of commodities sold in the store. The code symbol C is attached to the label L by printing or the like. The code symbol C retains information concerning a commodity to which the code symbol C is attached (hereinafter referred to as code data as well) in a state in which the information is encoded into a two-dimensional code. The two-dimensional code may be a one-dimensional barcode. In this case, a plurality of one-dimensional barcodes may be inscribed to form the two-dimensional code.

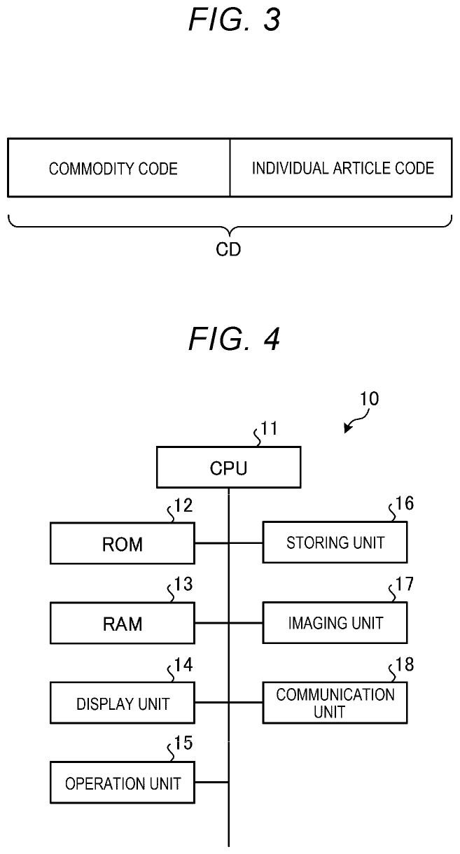

FIG. 3 is a diagram schematically illustrating an example of the code data retained by the code symbol C. As illustrated in FIG. 3, the code symbol C retains a commodity code and an individual article code as code data CD. The commodity code is, for example, an SKU (Sock Keeping Unit) code or a JAN (Japanese Article Number) code and is identification information capable of identifying a type (a form) of a commodity to which the label L is attached. The individual article code is unique information not overlapping information of other labels L (or code symbols C) and functions as identification information capable of identifying a commodity in an individual article unit.

A wireless tag TG is attached to the label L. The wireless tag TG stores tag data in a not-illustrated storage medium. Specifically, the wireless tag TG retains tag data including an individual article code. The individual article code retained by the wireless tag TG is the same as the individual article code retained by the code symbol C of the label L to which the wireless tag TG is attached. That is, the code symbol C and the wireless tag TG attached to the same label L or commodity retain the same individual article code.

In at least one embodiment, the code data CD retains the commodity code but may retain commodity information explained below instead of the commodity code. In this embodiment, the code symbol C and the wireless tag TG are attached to the same label L. However, not only this, but the code symbol C and the wireless tag TG may be attached to different labels L or media. However, the code symbol C and the wireless tag TG retaining the same individual article code are attached to the same commodity.

Referring back to FIG. 1, the server device 30 is an example of an information processing device and is realized by a store server or the like. In this embodiment, an example is explained in which the server device 30 is realized by a single device. However, the server device 30 may be realized by a plurality of devices according to a technique such as Cloud computing.

The server device 30 performs transmission and reception of various kinds of information to and from the terminal device 10 and the gate device 20. For example, if a commodity code is transmitted from the terminal device 10, the server device 30 provides commodity information including a commodity name and a price of a commodity corresponding to the commodity code to the terminal device 10 at a transmission source. If an individual article code of a commodity, for which settlement processing is completed, is transmitted from the terminal device 10, the server device 30 stores the individual article code in a storing unit 34 (storage) (see FIG. 6) explained below or the like. If an individual article code is transmitted from the gate device 20, the server device 30 collates the individual article code with stored individual article codes and executes processing relating to informing according to a result of the collation.

The configurations of the devices included in the store system 1 explained above are explained.

FIG. 4 is a diagram illustrating an example of a hardware configuration of the terminal device 10. As illustrated in FIG. 4, the terminal device 10 includes a CPU (Central Processing Unit) 11, a ROM (Read Only Memory) 12, a RAM (Random Access Memory) 13, a display unit 14, an operation unit 15, a storing unit 16 (storage), an imaging unit 17, and a communication unit 18.

The CPU 11 is an example of a processor and collectively controls the units of the terminal device 10. The ROM 12 stores various programs. The RAM 13 is a work space in which programs and various data are loaded. The CPU 11, the ROM 12, and the RAM 13 realize a computer configuration of the terminal device 10 and function as a control unit (controller) of the terminal device 10.

The display unit 14 is a display device such as an LCD (Liquid Crystal Display) . The display unit 14 displays various kinds of information and screens according to control by the CPU 11. The operation unit 15 includes an input device such as a keyboard or a mouse and outputs a signal corresponding to user operation to the CPU 11. The operation unit 15 may be a touch panel provided on the surface of the display unit 14.

The storing unit 16 is a storage device such as a HDD (Hard Disk Drive) or a flash memory. The storing unit 16 stores various programs to be executed by the CPU 11, setting information, and the like. For example, the storing unit 16 may store a program (an application program) for executing registration and settlement processing for commodities explained below, setting information for connection to the network N (the server device 30), and the like.

The imaging unit 17 is an imaging device including an imaging element such as a CMOS (Complementary Metal-Oxide Semiconductor) or a CCD (Charge Coupled Device). In at least one embodiment, the imaging unit 17 is mainly used for reading (imaging) of the code symbol C attached to a commodity.

The communication unit 18 is a communication interface connectable to the network N. By being connected to the network N, the communication unit 18 transmits and receives various kinds of information to and from an external device such as the server device 30 connected to the network N.

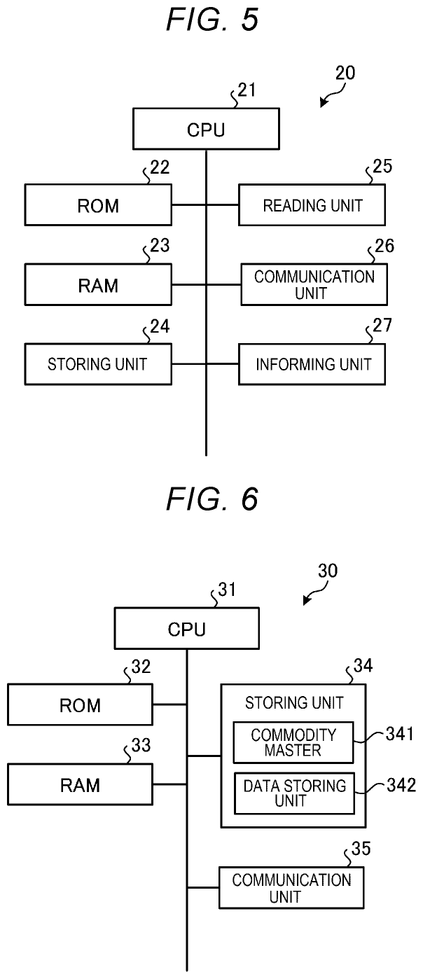

FIG. 5 is a diagram illustrating an example of a hardware configuration of the gate device 20. As illustrated in FIG. 5, the gate device 20 includes a CPU 21, a ROM 22, a RAM 23, a storing unit 24 (storage) , a reading unit 25, a communication unit 26, and an informing unit 27 (a communication interface informer).

The CPU 21 is an example of a processor and collectively controls the units of the gate device 20. The ROM 22 stores various programs. The RAM 23 is a work space in which programs and various data are loaded. The CPU 21, the ROM 22, and the RAM 23 realize a computer configuration of the gate device 20 and function as a control unit of the gate device 20.

The storing unit 24 is a storage device such as a HDD or a flash memory. The storing unit 24 stores various programs to be executed by the CPU 21, setting information, and the like.

The reading unit 25 is a reading device for reading tag data from the wireless tag TG. Specifically, the reading unit includes an antenna that radiates a radio wave for communicating with the wireless tag TG. The reading unit 25 radiates, under control by the CPU 21, a radio wave for reading the wireless tag TG from the antenna and receives, via the antenna, a radio wave emitted by the wireless tag TG receiving the radio wave to read the tag data stored in the wireless tag TG.

The communication unit 26 is a communication interface connectable to the network N. By being connected to the network N, the communication unit 26 transmits and receives various kinds of information to and from an external device such as the server device 30 connected to the network N.

The informing unit 27 is a device for performing informing. For example, the informing unit 27 may be a sound output device such as a speaker or a buzzer that provides an audible notification. The informing unit 27 may be a light emitting device such as a lamp that provides light emission as a visible notification. The informing unit 27 may be a display device that performs informing with a display of a message or the like.

FIG. 6 is a diagram illustrating an example of a hardware configuration of the server device 30. As illustrated in FIG. 6, the server device 30 includes a CPU 31, a ROM 32, a RAM 33, a storing unit 34, and a communication unit 35.

The CPU 31 is an example of a processor and collectively controls the units of the server device 30. The ROM 32 stores various programs. The RAM 33 is a work space in which programs and various data are loaded. The CPU 31, the ROM 32, and the RAM 33 realize a computer configuration of the server device 30 and function as a control unit (controller) of the server device 30.

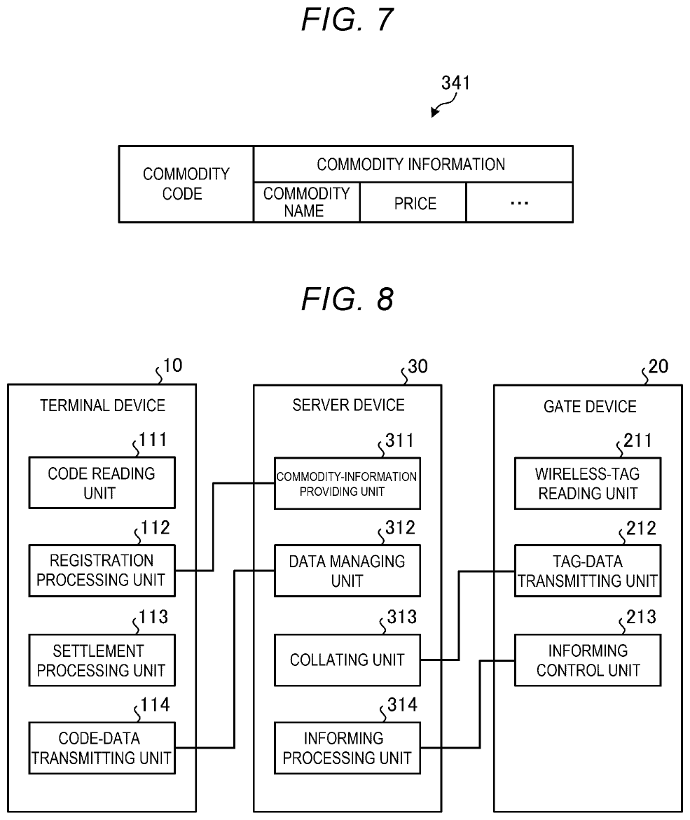

The storing unit 34 (storage) is a storage device such as a HDD or a flash memory. The storing unit 34 stores various programs to be executed by the CPU 31, setting information, and the like. The storing unit 34 stores a commodity master 341. The commodity master 341 is a data table correlating commodity codes of commodities sold in the store and commodity information relating to the commodities and has, for example, a data configuration illustrated in FIG. 7.

FIG. 7 is a diagram schematically illustrating an example of the data configuration of the commodity master 341. As illustrated in FIG. 7, the commodity master 341 stores commodity information in correlation with a commodity code. The commodity information includes information such as a commodity name and a price. The commodity name is information indicating a name of a commodity corresponding to the commodity code. The price is information indicating a price (a unit price) of the commodity corresponding to the commodity code. Items included in the commodity information are not limited to the example illustrated in FIG. 7. For example, the commodity information may include an image showing the commodity corresponding to the commodity code and information for explaining details of the commodity. The commodity master 341 is not always limited to a form included in the server device 30. For example, the commodity master 341 may be provided in a POS terminal, a store server provided in the store, or the like.

Referring back to FIG. 6, the explanation of the server device 30 is continued. The storing unit 34 includes a data storing unit 342 for storing an individual article code transmitted from the terminal device 10. The data storing unit 342 sequentially stores, under control by the CPU 31, an individual article code transmitted from the terminal device 10.

If code data is transmitted from the terminal device 10, the storing unit 34 may sequentially store the code data. The number of individual article codes stored by the storing unit 34 is not particularly limited. For example, an upper limit such as ten thousand may be provided and the individual article codes may be deleted in order from an individual article code stored earliest. Alternatively, as an example of a method of deleting the individual article codes, the individual article codes maybe deleted starting from a settlement date. In this case, individual article codes having settlement dates before DD day of MM month, YY year may be set to be deleted.

The communication unit 35 is a communication interface connectable to the network N. By being connected to the network N, the communication unit 35 transmits and receives various kinds of information to and from external devices such as the terminal device 10 and the gate device 20 connected to the network N.

Functional configurations of the terminal device 10, the gate device 20, and the server device 30 are explained. FIG. 8 is a diagram illustrating an example of the functional configurations of the terminal device 10, the gate device 20, and the server device 30.

As illustrated in FIG. 8, the terminal device 10 includes a code reading unit 111 (reader), a registration processing unit 112, a settlement processing unit 113 (settler), and a code-data transmitting unit 114 as functional units.

A part or all of the functional units included in the terminal device 10 may be software components realized by cooperation of the processor (for example, the CPU 11) and a program stored in the memory (for example, the ROM 12 or the storing unit 16) of the terminal device 10. A part or all of the functional units included in the terminal device 10 may be hardware components realized by a dedicated circuit or the like mounted on the terminal device 10.

The code reading unit 111 is an example of first reading means. The code reading unit 111 cooperates with the imaging unit 17 to read code data from a code symbol attached to a commodity. Specifically, the code reading unit 111 detects a code symbol from an image captured by the imaging unit 17 and decodes the detected code symbol to read code data retained in the code symbol.

The registration processing unit 112 executes, based on a commodity code included in the code data read by the code reading unit 111, registration processing for a commodity purchased by a customer. Specifically, the registration processing unit 112 performs inquiry processing for transmitting a commodity code to the server device 30 to acquire commodity information of a commodity corresponding to the commodity code from the server device 30. The registration processing unit 112 stores (registers) code data and commodity information acquired based on the code data in the RAM 13 or the like in correlation with each other to execute registration processing for a purchase target commodity.

The settlement processing unit 113 is an example of settling means. The settlement processing unit 113 executes settlement processing for the commodity registered by the registration processing unit 112. Specifically, if an end of commodity registration is instructed via the operation unit 15, the settlement processing unit 113 calculates a total amount of the purchase target commodity based on a price included in commodity information of registered commodities. The settlement processing unit 113 executes the settlement processing for settling a total amount of the commodity with an amount paid by a user.

A settlement method is not particularly limited and various methods can be adopted as the settlement method. For example, the settlement processing unit 113 may perform credit card settlement based on a credit card number input via the operation unit 15 or a credit card number stored in advance. In this case, the settlement processing unit 113 executes the credit card settlement by notifying the credit card number and a total amount of commodities to a credit card company (a credit server or the like) on the outside via the network N or a not-illustrated network.

For example, the settlement processing unit 113 may perform electronic settlement based on electronic money information. In this case, the electronic money information may be stored in the terminal device 10 in advance or the settlement processing unit 113 may cooperate with the code reading unit 111 to acquire the electronic money information from a code symbol. The settlement processing unit 113 executes the electronic money settlement by notifying the electronic money information and a total amount of commodities to an operation company (an electronic settlement server or the like) that provides an electronic money settlement service via the network N or a not-illustrated network.

The code-data transmitting unit 114 (transmitter) is an example of first transmitting means. The code-data transmitting unit 114 transmits an individual article code of a commodity, for which settlement processing is completed by the settlement processing unit 113, to the server device 30. Specifically, if the settlement processing by the settlement processing unit 113 is completed, the code-data transmitting unit 114 transmits individual article codes included in code data of commodities, which are targets of the settlement processing, to the server device 30.

With the configurations of the functional units explained above, in the terminal device 10, the customer himself or herself is capable of performing registration and settlement processing for a purchase target commodity by operating the terminal device 10. The code-data transmitting unit 114 may transmit the code data to the server device 30. The code-data transmitting unit 114 may transmit the individual article code (or the code data) to the server device 30 together with a date and time (a settlement date) when the settlement processing is completed.

The gate device 20 includes, as illustrated in FIG. 8, a wireless-tag reading unit 211 (reader), a tag-data transmitting unit 212 (transmitter), and an informing control unit 213 (informing controller) as functional units.

A part or all of the functional units included in the gate device 20 maybe software components realizedby cooperation of the processor (for example, the CPU 21) and a program stored in the memory (for example, the ROM 22 or the storing unit 24) of the gate device 20. A part or all of the functional units included in the gate device 20 may be hardware components realized by a dedicated circuit or the like mounted on the gate device 20.

The wireless-tag reading unit 211 is an example of second reading means. The wireless-tag reading unit 211 cooperates with the reading unit 25 to read tag data from the wireless tag TG attached to a commodity. Specifically, the wireless-tag reading unit 211 controls the operation of the reading unit 25 to acquire the tag data read from the wireless tag TG by the reading unit 25.

The tag-data transmitting unit 212 is an example of second transmitting means (transmitter). The tag-data transmitting unit 212 transmits an individual article code of a commodity read by the wireless-tag reading unit 211 to the server device 30. Specifically, if the wireless-tag reading unit 211 reads tag data, the tag-data transmitting unit 212 transmits an individual article code included in the tag data to the server device 30.

With the configurations of the functional units explained above, if a customer carrying a commodity passes the gate device 20, the gate device 20 reads out an individual article code attached to the commodity from the wireless tag TG and transmits the read-out individual article code to the server device 30. Consequently, for example, if the gate device 20 is provided near the exit of the store, whereby, if a customer carrying a commodity, for which the settlement processing is completed, exits the store, the gate device 20 transmits an individual article code attached to the commodity to the server device 30. The tag-data transmitting unit 212 may transmit the tag data to the server device 30.

The informing control unit 213 (controller) controls the operation of the informing unit 27. Specifically, if the server device 30 instructs the informing control unit 213 to perform informing (hereinafter referred to as informing instruction as well), the informing control unit 213 performs the informing by causing the informing unit 27 to operate.

On the other hand, the server device 30 includes, as illustrated in FIG. 8, a commodity-information providing unit 311, a data managing unit 312, a collating unit 313, and an informing processing unit 314 as functional units.

A part or all of the functional units included in the server device 30 may be software components realized by cooperation of the processor (for example, the CPU 31) and a program stored in the memory (for example, the ROM 32 or the storing unit 34) of the server 30. Apart or all of the functional units included in the server device 30 may be hardware components realized by a dedicated circuit or the like mounted on the server device 30.

The commodity-information providing unit 311 provides commodity information stored in the commodity master 341 to the terminal device 10. Specifically, if an inquiry about a commodity code is received from the terminal device 10, the commodity-information providing unit 311 refers to the commodity master 341 and reads out commodity information corresponding to the commodity code from the commodity master 341. The commodity-information providing unit 311 transmits the commodity information to the terminal device 10 at an inquiry source.

The data managing unit 312 is an example of first receiving means (receiver) and storage control means (controller). The data managing unit 312 executes storage and management of data transmitted from the terminal device 10. Specifically, if receiving an individual article code of a commodity, for which settlement processing is completed, from the terminal device 10, the datamanagingunit 312 sequentiallystores the individual article code in the data storing unit 342.

If code data is transmitted from the terminal device 10, the data managing unit 312 may store the code data received from the terminal device 10 in the data storing unit 342 or may extract individual article data included in the code data and store the individual article data in the data storing unit 342. If a transaction date and time is transmitted from the terminal device 10 together with an individual article code (or code data), the data managing unit 312 stores the transmitted individual article code (or code data) in the data storing unit 342 in correlation with the transaction date and time.

If an upper limit value of the number of individual article codes stored in the data storing unit 342 is decided, the data managing unit 312 may sequentially delete individual article codes from an individual article code stored earliest such that the number of individual article code is equal to or smaller than the upper limit value. Alternatively, as an example of amethodofdeletingthe individual article codes, the individual article codes may be deleted starting from a settlement date. In this case, individual article codes having settlement dates before DD day of MM month, YY year may be set to be deleted.

The collating unit 313 is an example of second receiving means and collating means in the form of processing circuitry. The collating unit 313 executes processing for collating an individual article code read by the gate device 20 with individual article codes stored in the data managing unit 312. Specifically, the collating unit 313 receives an individual article code from the gate device 20. The collating unit 313 collates the individual article code received from the gate device 20 with each of the individual article codes stored in the data managing unit 312 and determines whether a coinciding individual article code is present in the data storing unit 342.

If tag data is transmitted from the gate device 20, the collating unit 313 only has to extract an individual article code included in the tag data and collate the extracted individual article code with the individual article codes stored in the data managing unit 312.

The informing processing unit 314 is an example of informing means. The informing processing unit 314 gives an informing instruction to the gate device 20 according to a collation result of the collating unit 313. Specifically, if it is determined as a result of the collation by the collating unit 313 that a coinciding individual article code is absent in the data storing unit 342, the informing processing unit 314 determines that an unsettle commodity is detected and gives an informing instruction to the gate device 20. In this case, the informing control unit 213 of the gate device 20 informs a customer (that is, provides a notification operation) and an employee (a store clerk or the like) of the store passing the gate device 20 by causing the informing unit 27 to operate according to the informing instruction from the informing processing unit 314.

In this way, the server device 30 stores data of individual article codes of commodities, for which settlement is completed, in the data storing unit 342 and acquires, via the gate device 20 set, for example, near the exit, an individual article code of a commodity carried by the customer. The server device 30 collates the acquired individual article code and the individual article codes stored in the data storing unit 342 to determine whether the commodity is a commodity for which settlement is completed. If a coinciding individual article code is absent in the data storing unit 342, that is, if an unsettled commodity is detected, the server 30 informs via the informing unit 27 provided in the gate device 20.

Consequently, if an unsettled commodity is taken out from the store, the server device 30 can detect the commodity and inform the customer, the store clerk, or the like. Therefore, it is possible to achieve an effect of preventing a fraudulent act such as a commodity theft. In the store system 1 in this embodiment, the code symbol C and the wireless tag TG can be concurrently used to manage commodities in an individual article unit. Therefore, even if the terminal device 10 cannot read the wireless tag TG, the management in the individual article unit can be efficiently performed.

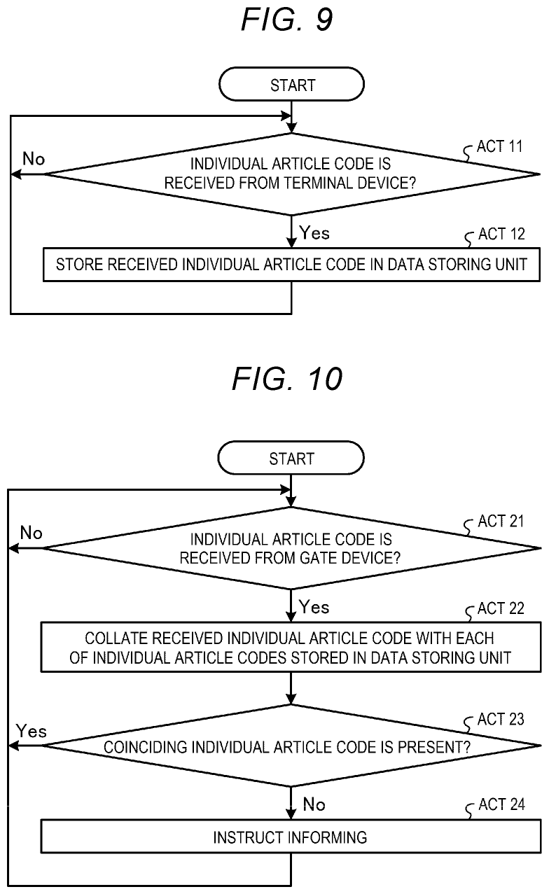

An operation example of the server device 30 explained above is explained below with reference to FIGS. 9 and 10.

FIG. 9 is a flowchart illustrating an example of processing executed by the server device 30. First, the data managing unit 312 stays on standby until a settled individual article code is received from the terminal device 10 (No in Act 11). If receiving an individual article code from the terminal device 10 (Yes in Act 11) , the data managing unit 312 stores the received individual article code in the data storing unit 342 (Act 12) and returns to the processing in Act 11.

According to the processing illustrated in FIG. 9, an individual article code of a commodity, for which settlement is completed in each of the terminal devices 10, is sequentially stored in the data storing unit 342. Therefore, by performing collation based on the individual article codes stored in the data storing unit 342, it is possible to easily discriminate whether the commodity is a settled commodity.

FIG. 10 is a flowchart illustrating another example of the processing executed by the server device 30. First, the collating unit 313 stays on standby until an individual article code is received from the gate device 20 (No in Act 21). If receiving an individual article code from the gate device 20 (Yes in Act 21) , the collating unit 313 collates the received individual article code with each of the individual article codes stored in the data storing unit 342 (Act 22) and determines whether a coinciding individual article code is present (Act 23).

If determining that a coinciding individual article code is present in the data storing unit 342 (Yes in Act 23), the collating unit 313 returns the processing to Act 21. On the other hand, if the collating unit 313 determines that a coinciding individual article code is absent in the data storing unit 342 (No in Act 23), the informing processing unit 314 determines that an unsettled commodity is detected, transmits an informing instruction to the gate device 20 to inform the customer, the store clerk, or the like (Act 24), and returns the processing to Act 21.

According to the processing illustrated in FIG. 10, it is possible to discriminate whether a customer passing the gate device 20 carries an unsettled commodity for which settlement is not completed and inform if the customer carries an unsettled commodity. Therefore, with the store system 1 (the server device 30), it is possible to prevent an unsettled commodity from being taken out to the outside of the store.

As explained above, if an individual article code is read from a code symbol attached to a settlement target commodity by the terminal device 10, the server device 30 receives (acquires) the individual article code from the terminal device 10 and stores the individual article code in the data storing unit 342. If an individual article code of a commodity is read from a wireless tag attached to the commodity by the gate device 20 provided at the exit or the like of the store, the server device 30 receives (acquires) the individual article code and collates the individual article code with each of the individual article codes stored in the data storing unit 342. The server device 30 informs if a coinciding individual article code is absent in the data storing unit 342.

Consequently, even if settlement is performed in the terminal device 10 by operation of the customer himself or herself, the server device 30 can efficiently perform detection of an unsettled commodity. In the store system 1, an individual article code capable of identifying a commodity in an individual article unit is attached to the commodity in both forms of a code symbol and a wireless tag. Therefore, even if a customer performs settlement using the terminal device 10 such as a smartphone carried by the customer, it is possible to collect and store an individual article code of a settled commodity. Therefore, in the store system 1, it is possible to efficiently perform detection of an unsettled commodity and achieve improvement of practical use (for example, by reducing or preventing incidents of fraud).

If a customer himself or herself perform operation relating to settlement, the customer sometimes hesitates in taking out a commodity, for which settlement is completed, to the outside of the store. In such a case, in the store system 1, by passing the gate device 20, the customer can ascertain that the commodity is settled. Therefore, it is possible to psychologically support (provide assurance to) the customer who may have hesitation or confusion as to the status of the commodity or the like and achieve improvement of convenience of the customer.

An embodiment as explained above can be modified and carried out as appropriate by changing apart of the components or the functions included in the devices explained above. Therefore, in the following explanation, several modifications relating to the embodiment explained above are explained as other embodiments. In the following explanation, differences from the embodiment explained above are mainly explained. Detailed explanation is omitted about similarities to the content explained above. The modifications explained below may be individually carried out or may be carried out in combination as appropriate.

### Modification 1

In the embodiment explained above, the terminal device 10 transmits an individual article code to the server device 30 at a stage when the settlement processing is completed. However, the terminal device 10 may transmit the individual article code to the server device 30 at a stage of the registration processing for a commodity. A configuration example of the store system 1 according to this modification is explained below

First, functional units of the terminal device 10 and the gate device 20 according to this modification are explained with reference to FIG. 8.

The registration processing unit 112 of the terminal device 10 executes, based on a commodity code included in code data read by the code reading unit 111, registration processing for a commodity purchased by a customer. Specifically, every time coded data is read by the code reading unit 111, the registration processing unit 112 transmits the code data to the server device 30. That is, the registration processing unit 112 transmits an induvial article code to the server device 30 at a stage of commodity registration. If acquiring commodity information from the server device 30 according to the transmission of the code data, the registration processing unit 112 stores the acquired commodity information in the RAM 13 or the like in correlation with the code data to execute registration processing for the purchase target commodity.

If operation for cancelling a registered commodity is performed in the terminal device 10, the registration processing unit 112 deletes code data and commodity information of the relevant commodity stored in the RAM 13 or the like and notifies the code data (or an individual article code) of the cancellation target commodity to the server device 30.

The registration processing unit 112 of the terminal device 10 may transmit identification information capable of identifying the transaction (hereinafter referred to as transaction ID as well) together with the code data.

On the other hand, if code data is transmitted from the terminal device 10, the commodity-information providing unit 311 of the gate device 20 reads out, from the commodity master 341, commodity information corresponding to a commodity code included in the code data and provides the commodity information to the terminal device 10 at a transmission source.

If code data is transmitted from the terminal device 10, the data managing unit 312 of the gate device 20 stores an individual article code included in the code data in the data storing unit 342. If a code data (or an individual article code) of a cancellation target commodity is notified from the terminal device 10, the data managing unit 312 deletes individual article data of the relevant commodity from the data storing unit 342. If a transaction ID is transmitted from the terminal device 10, the data managing unit 312 may store the transaction ID and the individual article code in correlation with each other.

At a stage when the individual article code is stored in the data storing unit 342, it is uncertain whether settlement of a commodity corresponding to the individual article code is performed. Therefore, the data managing unit 312 stores flag information for identifying whether the commodity is settled in the data storing unit 342 in correlation with the individual article code.

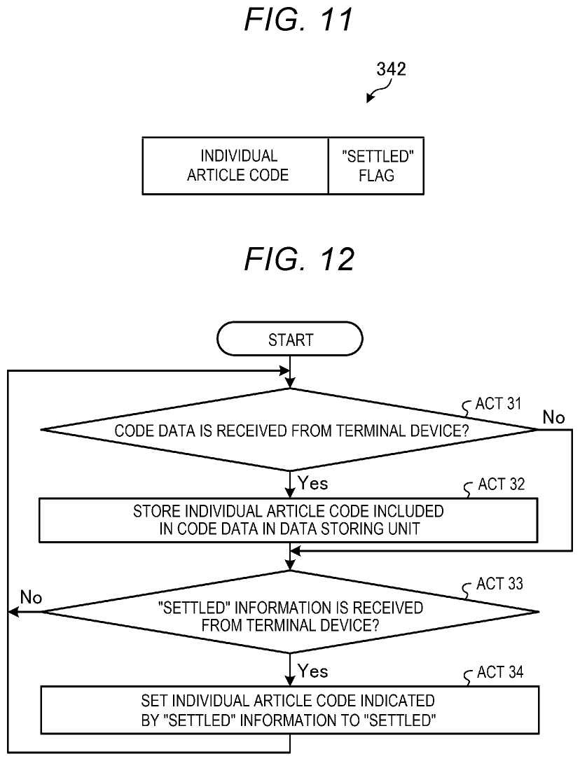

FIG. 11 is a diagram schematically illustrating an example of a data configuration of an individual article code stored by the data storing unit 342 in this modification. As illustrated in FIG. 11, the individual article code and flag information (a “settled” flag) for discriminating whether a commodity is settled are stored in the data storing unit 342 in correlation with each other. At a stage when the individual article code is stored, a value indicating unsettlement is set in the “settled” flag.

If a commodity is regarded as settled at a stage of registration or in the case of specifications or the like in which settlement of a registered commodity is always performed, only the individual article code may be stored in the data storing unit 342.

The settlement processing unit 113 of the terminal device 10 executes settlement processing for a commodity registered by the registration processing unit 112. If the settlement processing is completed, the settlement processing unit 113 transmits information for notifying a settled commodity (settlement completion information) to the server device 30. The settlement completion information may be, for example, settlement completion information explicitly including an individual article code of the commodity for which the settlement processing is performed. If a transaction ID is transmitted at a registration time of the commodity, the transaction ID may be transmitted as the settlement completion information.

On the other hand, if receiving the settlement completion information from the terminal device 10, the data managing unit 312 of the gate device 20 updates a “settled” flag correlated with an individual article code of a commodity indicated by the settlement completion information to a value indicating “settled”. For example, if an individual article code is indicated as the settlement completion information, the data managing unit 312 updates the “settled” flag correlated with the relevant individual article code to a value indicating “settled”. For example, if a transaction ID is indicated as the settlement completion information, the data managing unit 312 updates a “settled” flag of an individual article code correlatedwith the relevant transaction ID to a value indicating “settled”.

If receiving an individual article code from the gate device 20, the collating unit 313 of the gate device 20 collates the individual article code with each of individual article codes for which “settled” flags are set to “settled” among the individual article codes stored in the data storing unit 342 to determine whether the individual article codes coincide. Consequently, as in the embodiment explained above, it is possible to execute collation with an individual article code of a commodity for which settlement processing is completed.

The collating unit 313 may collate the individual article code with individual article codes including an individual article code for which a “settled” flag is set to “unsettled” . In this case, if the individual article code transmitted from the gate device 20 coincides with the individual article code for which the “settled” flag is set to “unsettled”, the informing processing unit 314 may inform a settlement failure of a registered commodity by informing with an informing method different from the method in the embodiment explained above.

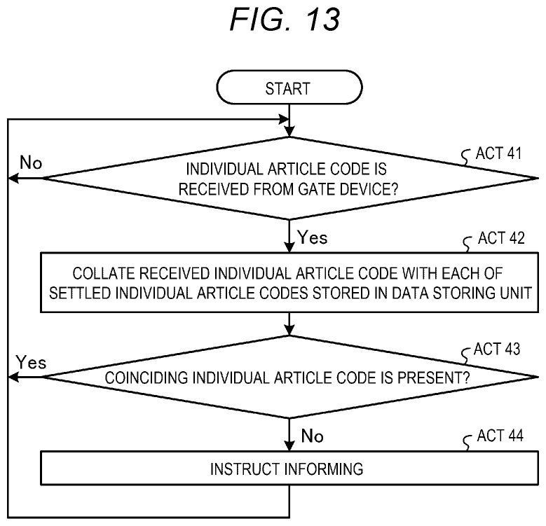

An operation example of the server device 30 is explained below with reference to FIGS. 12 and 13.

FIG. 12 is a flowchart illustrating an example of processing executed by the server device 30 in this modification. First, the data managing unit 312 stays on standby until code data of a registration target commodity is transmitted from the terminal device 10 (No in Act 31 to No in Act 33). If receiving code data from the terminal device 10 (Yes in Act 31) , the data managing unit 312 stores an individual article code included in the received code data in the data storing unit 342 (Act 32) and shifts to Act 33.

The data managing unit 312 stores a “settled” flag set to an unsettled state in correlation with the individual article code. In the case of a configuration in which a transaction ID is transmitted from the terminal device 10, the data managing unit 312 stores the transaction ID in correlation with the individual article code. The commodity-information providing unit 311 reads out, in the background of Act 32, from the commodity master 341, commodity information corresponding to a commodity code included in the code data transmitted from the terminal device 10 and provides the commodity information to the terminal device 10.

In subsequent Act 33, the data managing unit 312 stays on standby until “settled” information is transmitted from the terminal device 10 (No in Act 33 to No in Act 31) . If receiving “settled” information from the terminal device 10 (Yes in Act 33) , the data managing unit 312 sets a “settled” flag correlated with an individual article code indicated by the “settled” information to “settled” (Act 34) and returns the processing to Act 31.

According to the processing illustrated in FIG. 12, an individual article code of a commodity registered in each of the terminal devices 10 is sequentially stored in the data storing unit 342. Among individual article codes of commodities stored in the data storing unit 342, an individual article code of a commodity, for which settlement processing is completed in each of the terminal devices 10, is retained in an identifiable state. Therefore, it is possible to easily discriminate whether a commodity is a settled commodity by performing collation based on an individual article code of a settled commodity among the individual article codes stored in the data storing unit 342.

FIG. 13 is a flowchart illustrating another example of the processing executed by the server device 30 in this modification. First, the collating unit 313 stays on standby until an individual article code is received from the gate device 20 (No in Act 41). If receiving an individual article code from the gate device 20 (Yes in Act 41), the collating unit 313 collates the individual article code and each of the individual article codes, the “settled” flags of which are “settled”, stored in the data storing unit 342 (Act 42) and determines whether a coinciding individual article code is present (Act 43).

If determining that a coinciding individual article code is present in the data storing unit 342 (Yes in Act 43), the collating unit 313 returns the processing to Act 41. If the collating unit 313 determines that a coinciding individual article code is absent in the data storing unit 342 (No in Act 43), the informing processing unit 314 transmits an informing instruction to the gate device 20 to inform the customer, the store clerk, or the like (Act 44) and returns the processing to Act 41.

According to the processing illustrated in FIG. 13, it is possible to inform if a customer passing the gate device 20 carries an unsettled commodity for which settlement is not completed. Therefore, with the store system 1 (the server device 30), it is possible to prevent an unsettled commodity from being taken out to the outside of the store. It is possible to achieve the same effects as the effects in the embodiment explained above.

### Modification 2

In the embodiment explained above, the server device 30 collates the individual article codes. However, not only this, but another device may perform collation. For example, if the gate device 20 is an example of an information processing device, the gate device 20 may collate the individual article codes.

In this case, the data managing unit 312 of the server device 30 transmits, to the gate device 20, individual article data (or code data) transmitted from the terminal device 10 and stores the individual article data (or the code data) in the data storing unit 342 secured in the storing unit 24.

On the other hand, the gate device 20 according to this modification includes the functional units of the collating unit 313 and the information processing unit 314 explained above and executes the operation relating to the collation and the informing of the individual article codes in the gate device 20. Consequently, it is possible to achieve the same effects as the effects of the embodiment explained above.

If the gate device 20 includes the function of the data managing unit 312, an individual article code transmitted from the server device 30 may be stored in the storing unit 24 (the data storing unit 342) of the gate device 20.

### Modification 3

In the embodiment explained above, the individual article data is stored in the data storing unit 342 included in the server device 30 (or the gate device 20). However, not only this, but the individual article data may be stored in an external storage device (for example, a database server) accessible by the server device 30 (or the gate device 20).

### Modification 4

In the embodiment explained above, the server device 30 is one server device. However, not only this, but the server device 30 may be configured by a plurality of server devices. In this case, for example, the commodity master 341 and the data storing unit 342 of the storing unit 34 are respectively included in different server devices. A commodity code is transmitted to the server device including the commodity master 341 from the terminal device 10. If receiving the commodity code, the server device provides commodity information including a commodity name and a price of a commodity corresponding to the commodity code to the terminal device 10 at a transmission source. An individual article code of a commodity, for which settlement processing is completed, is transmitted to the server device including the data storing unit 342 from the terminal device 10. If receiving the individual article code, the server device stores the individual article code in the data storing unit 342. Thereafter, if an individual article code is transmitted from the gate device 20, the server including the data storing unit 342 may collate the individual article code with the stored individual article code and execute processing relating to informing according to a result of the collation.

### Modification 5

In the embodiment explained above, the terminal device 10 executes the program (the application program) stored in (the storing unit 16 of) the terminal device 10 to execute the registration processing and the settlement processing for commodities. However, not only this, but, for example, the registration processing and the settlement processing for commodities may be realized in a Web application form or the like in which an external device such as the server device 30 or a Web application server executes the registration processing and the settlement processing for commodities. In this case, the terminal device 10 may function as an interface device that receives information from and outputs information to the external device. The terminal device 10 acquires processing results of the registration processing and the settlement processing executed by the external device and causes the display device 14 to display the processing results.

The programs executed by the devices in the embodiment and the modifications explained above are provided in a state in which the programs are incorporated in advance in the ROM, the storing unit, or the like. The programs executed by the devices in the embodiment and the modifications may be provided while being recorded in a computer-readable recording medium such as a CD-ROM, a flexible disk (FD), a CD-R, or a DVD (Digital Versatile Disk) as a file of an installable format or an executable format.

For example, the programs executed by the devices in the embodiment and the modifications explained above may be stored on a computer connected to a network such as the Internet and provided by being downloaded through the network. The programs executed by the devices in the embodiment and the modifications may be provided or distributed through the network such as the Internet.

An embodiment and the modifications are explained above. However, the embodiment and the modifications are presented as examples and are not intended to limit the scope of the invention. Any such embodiments and modifications can be implemented in other various forms. Various omissions, substitutions, and changes can be made without departing from the spirit of the invention. Such embodiments andmodifications are included in the scope and the gist of the invention and included in the subject matter described in claims and the scope of equivalents.

What is claimed is:

1. An information processing device comprising:
a first receiver configured to receive, from a terminal device that performs settlement of a commodity, an individual article code capable of identifying the commodity in an individual article unit, the individual article code obtained by the terminal device reading a code symbol attached to the commodity;
a storage controller configured to store the individual article code received by the first receiver in a storage;
a second receiver configured to receive, from a gate device provided in a predetermined position of a store selling the commodity, the individual article code of the commodity obtained by the gate device reading a wireless tag attached to the commodity;
a processor configured to collate the individual article code received by the second receiver with each of individual article codes stored in the storage; and
a communication interface configured to provide a notification, when, as a result of the collation, a coinciding individual article code is absent in the storage.

2. The device according to claim 1, wherein the first receiver is configured to receive an individual article code of a commodity, for which settlement is completed, from the terminal device.

3. The device according to claim 1, wherein
the first receiver is configured to receive the individual article code of the commodity from the terminal device every time the reading of the code symbol attached to the commodity is performed by the terminal device,
the storage controller is configured to set, when a commodity for which settlement is completed is notified from the terminal device, among the individual article codes stored in the storage, an individual article code of the notified commodity to indicate that the commodity has a settled status, and
the processor is configured to collate the individual article code with each of the individual article codes set to a settled status among the individual identification codes stored in the storage.

4. The device according to claim 1, wherein the communication interface is configured to provide the notification by causing a notification operation of the gate device.

5. An information processing method comprising:
causing a first receiver to receive, from a terminal device that performs settlement of a commodity, an individual article code capable of identifying the commodity in an individual article unit, the individual article code being obtained by the terminal device reading a code symbol attached to the commodity;
causing a storage controller to store the individual article code received by the first receiver in a storage;
causing a second receiver to receive, from a gate device provided in a predetermined position of a store selling the commodity, the individual article code of the commodity obtained by the gate device reading a wireless tag attached to the commodity;
causing a processor to collate the individual article code received by the second receiver with each of individual article codes stored in the storing unit; and
causing a communication interface to provide a notification when, as a result of the collation, a coinciding individual article code is absent in the storage.

6. An information processing system comprising:
a terminal device;
a gate device; and
an information processing device, wherein
the terminal device includes:
a first reader configured to read code data from a code symbol attached to a commodity;
a settler configured to execute settlement processing based on information included in the code data and configured to identify a type of the commodity; and
a first transmitter configured to transmit, to the information processing device, an individual article code included in the code data of the commodity, for which the settlement processing is completed, and configured to identify the commodity in an individual article unit,
the gate device including:
a second reader provided in a predetermined position of a store selling the commodity, the second reader configured to read an individual article code of the commodity from a wireless tag attached to the commodity; and
a second transmitter configured to transmit the individual article code read by the second reader to the information processing device, and
the information processing device including:
a first receiver configured to receive the individual article code from the terminal device;
a storage controller configured to store the individual article code received by the first receiver in a storage;
a second receiver configured to receive the individual article code from the gate device;
a processor configured to collate the individual article code received by the second receiver with each of individual article codes stored in the storage; and
a communication interface configured to provide a notification, when, as a result of the collation, a coinciding individual article code is absent in the storage.

7. The device according to claim 1, wherein the information processing device includes a server.

8. The device according to claim 1, wherein the communication interface includes a sound output device.

9. The device according to claim 8, wherein the communication interface includes at least one of a speaker or a buzzer.

10. The device according to claim 1, wherein the communication interface includes a light emitter.

11. The device according to claim 1, wherein the communication interface includes a display device.

12. The method according to claim 5, wherein terminal device includes a least one of a point of sale device or a portable terminal device.

13. The system according to claim 6, wherein the settlement processor is configured to calculate a total amount of a purchase target commodity.

14. The system according to claim 6, wherein the first receiver is configured to receive an individual article code of a commodity, for which settlement is completed, from the terminal device.

15. The device according to claim 6, wherein a the communication interface is configured to cause the gate device to perform a notification operation.
